(19) United States
(12) Patent Application Publication
(10) Pub. No.: US 2025/0147252 A1
(43) Pub. Date: May 8, 2025

(54) OPTICAL FIBER WITH WATER-BLOCKING COATING FOR USE IN HIGH FIBER DENSITY CABLES AND METHOD OF MAKING SAME

(71) Applicant: CORNING RESEARCH & DEVELOPMENT CORPORATION, Corning, NY (US)

(72) Inventors: Pushkar Tandon, Painted Post, NY (US); Kenneth Darrell Temple, JR., Newton, NC (US); Malgorzata Wojtczak-Michalska, Lodz (PL)

(21) Appl. No.: 19/014,818

(22) Filed: Jan. 9, 2025

Related U.S. Application Data
(63) Continuation of application No. PCT/US2023/026516, filed on Jun. 29, 2023.
(60) Provisional application No. 63/388,332, filed on Jul. 12, 2022.

(51) Int. Cl. G02B 6/44; C03C 25/1065; G02B 6/02

(52) U.S. Cl. CPC G02B 6/443; C03C 25/1065; G02B 6/02042; G02B 6/4434; G02B 6/44384; G02B 6/448; C03C 2218/32

(57) ABSTRACT

Embodiments of the disclosure relate to an optical fiber cable. The optical fiber cable includes a cable jacket having an inner surface and an outer surface. The inner surface defines a central bore extending along a longitudinal axis of the optical fiber cable. The optical fiber cable also includes a plurality of subunits disposed within the central bore. Each subunit includes a plurality of optical fibers. The plurality of optical fibers includes at least one water-blocking optical fiber. The at least one water-blocking optical fiber has an outermost coating layer of a UV-cured resin configured to absorb at least 20 grams of water per gram of the UV-cured resin. The optical fiber cable has a cross-sectional area defined by the outer surface of the cable jacket. The optical fiber cable has a fiber density of at least 4 fibers/mm² as measured at the cross-sectional area.

### CROSS-REFERENCE TO RELATED APPLICATIONS

This application is a continuation of International Application No. PCT/US2023/026516, filed Jun. 29, 2023, which claims the benefit of priority of U.S. Provisional Application Ser. No. 63/388,332 filed on Jul. 12, 2022, the content of which is relied upon and incorporated herein by reference in its entirety.

### BACKGROUND

The disclosure relates generally to optical fiber cables and, in particular, to high fiber density optical fiber cables and methods of forming same. Optical fibers are used to carry data throughout a telecommunications network. In general, there is a demand for higher speeds and larger capacities, which generally corresponds to a need for optical fiber cables containing more optical fibers. Further, it is desirable to increase the fiber count while maintaining the same cable size so that the cable is compatible with existing ductwork. Including more fibers within a cable of a given size increases the fiber density and decreases the available free space for movement of the optical fibers to avoid attenuation during bending. In view of the limited free space at high fiber densities, conventional cable structures, such as water-blocking powders, that do not present an issue at low fiber density and high free space can become sources of attenuation.

### SUMMARY

According to an aspect, embodiments of the disclosure relate to an optical fiber cable. The optical fiber cable includes a cable jacket having an inner surface and an outer surface. The outer surface defines an outermost surface of the optical fiber cable, and the inner surface defines a central bore extending along a longitudinal axis of the optical fiber cable. The optical fiber cable also includes a plurality of subunits disposed within the central bore. Each subunit of the plurality of subunits includes a plurality of optical fibers. The plurality of optical fibers of at least one subunit of the plurality of subunits includes at least one water absorbing optical fiber. The at least one water-blocking optical fiber has an outermost coating layer of a UV-cured resin configured to absorb at least 20 grams of water per gram of the UV-cured resin. The optical fiber cable has a cross-sectional area defined by the outer surface of the cable jacket, and the cross-sectional area is perpendicular to the longitudinal axis. The optical fiber cable has a fiber density of at least 4 fibers/mm² as measured at the cross-sectional area.

According to another aspect, embodiments of the disclosure relate to a method of forming a water-blocking optical fiber. In the method, a bare glass fiber is drawn from a glass preform within a furnace. The furnace is disposed at one end of a draw tower, and the drawing proceeds in a first direction. The bare optical fiber is redirected around at least one fluid bearing such that the drawing proceeds at least partially in a second direction. The second direction is different from the first direction. Each of a primary coating layer, a secondary coating layer, and an outermost coating layer is applied and UV cured. The outermost coating layer is formed from a solvent-free, UV-curable material configured to absorb at least 20 grams of water per gram of the solvent-free, UV-curable material.

Additional features and advantages will be set forth in the detailed description that follows, and, in part, will be readily apparent to those skilled in the art from the description or recognized by practicing the embodiments as described in the written description and claims hereof, as well as the appended drawings.

It is to be understood that both the foregoing general description and the following detailed description are merely exemplary and are intended to provide an overview or framework to understand the nature and character of the claims.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and the operation of the various embodiments.

FIG. 1 depicts a cross-sectional view of an optical fiber cable including a plurality of buffer tube subunits, according to a first exemplary embodiment;

FIG. 2 depicts a cross-sectional view of an optical fiber cable including a plurality of lumen subunits, according to a second exemplary embodiment;

FIG. 3 depicts a cross-sectional view of an optical fiber having a water-blocking coating, according to an exemplary embodiment; and

FIG. 4 depicts a schematic of an optical fiber draw tower for forming an optical fiber having a water-blocking coating, according to an exemplary embodiment.

### DETAILED DESCRIPTION

Referring generally to the figures, various embodiments of a high fiber density optical fiber cable having subunits containing one or more optical fibers with a water-blocking coating are provided. The high fiber density optical fiber cables include subunits having low free space such that the optical fibers within the subunits are in contact with each other. When conventional water-absorbing powders are used within such subunits, the powder particles can create points of attenuation along the optical fibers, especially during bending, because the close contact and low free space do not allow the optical fibers to move into low attenuation positions. Thus, by providing a water-blocking coating on one or more optical fibers within the subunit, the water-blocking material does not create points of attenuation when the optical fibers slide past or rub against each other. Further, the water-blocking coating may be made from a material having a lower coefficient of friction than a typical outer coating layer, such as a color layer, which facilitates sliding of the optical fibers, e.g., during bending. Advantageously, less than all of the optical fibers within the subunit need to include the coating, and in embodiments, sufficient water-blocking may be provided with only a single coated optical fiber within the subunit.

Additionally, the water-blocking material coated onto the optical fibers is a solvent-free, UV-curable material that can be applied during fiber drawing. As will be discussed below, embodiments of the disclosure relate to a method in which an optical fiber cable is drawn in a drawing tower, redirected around a fluid bearing, and then coated with coating layers, including the water-blocking material. This allows for a preparation of a water-blocking optical fiber using a single processing line. Exemplary embodiments of the high fiber density optical fiber cable and methods of forming same will be described in greater detail below and in relation to the figures provided herewith, and these exemplary embodiments are provided by way of illustration, and not by way of limitation.

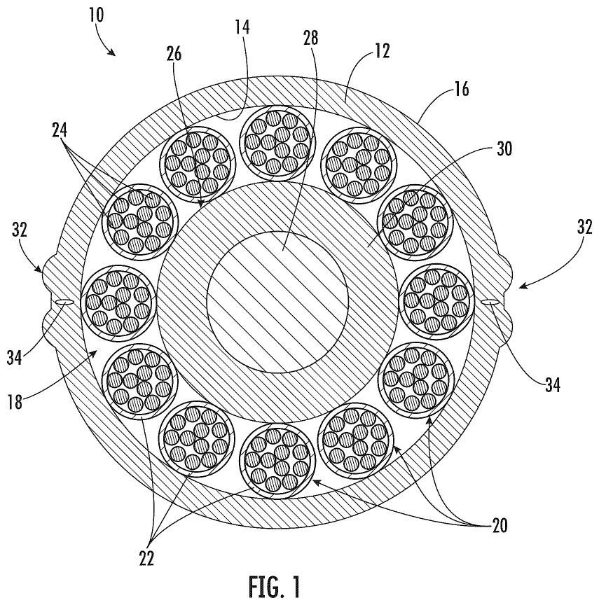

FIG. 1 depicts an embodiment of an optical fiber cable 10. The optical fiber cable 10 includes a cable jacket 12 having an inner surface 14 and an outer surface 16. In one or more embodiments, the outer surface 16 defines an outermost surface of the optical fiber cable 10. In one or more embodiments, the inner surface 14 defines a central bore 18 extending along a longitudinal axis of the optical fiber cable 10 (i.e., the axis extending along the length of the optical fiber cable 10). Disposed within the central bore 18 are a plurality of subunits 20. In the embodiment shown in FIG. 1, each subunit 20 is comprised of a buffer tube 22 and a plurality of optical fibers 24. The interior surface of the buffer tube 22 defines an inner diameter of the buffer tube 22, and the exterior surface of the buffer tube 22 defines an outer diameter of the buffer tube 22. In one or more embodiments, the outer diameter of the buffer tube 22 is 4 mm or less. In one or more embodiments, the inner diameter of the buffer tube 22 is at least 0.8 mm. In one or more embodiments, the wall thickness of the buffer tube 22 (i.e., distance between the interior surface and the exterior surface) is 1 mm or less, in particular 0.75 mm or less, and most particularly 0.5 mm or less. In one or more embodiments, the wall thickness of the buffer tube 22 is at least 0.1 mm.

In one or more embodiments, the plurality of subunits 20 are stranded around a central strength member 26. For example, the plurality of subunits 20 may be SZ-stranded around the central strength member 26. In other embodiments, the plurality of subunits 20 may be helically stranded around the central strength member 26. In one or more embodiments, including the embodiment shown in FIG. 1, the central strength member 26 includes a central strength element 28 and a upjacket 30. In one or more embodiments, the central strength element 28 provides tensile strength and bending stiffness. In one or more embodiments, the central strength element 28 is a fiber-reinforced plastic rod (such as a glass-reinforced plastic rod) or a metal wire. In one or more embodiments, the upjacket 30 provides the desired circumference for stranding of the subunits 20 around the central strength member 26.

In one or more embodiments, the cable jacket 12 may include locating elements 32 formed in the outer surface 16. In one or more embodiments, including the embodiment shown in FIG. 1, the locating elements 32 are raised ridges. An installer can use the locating elements 32 to find a place to split the cable jacket 12 to access the subunits 20 therein. In one or more embodiments, the cable jacket 12 may include an access feature 34 disposed between the inner surface 14 and the outer surface 16. In one or more embodiments, the access feature 34 may be a strip of dissimilar material embedded in the cable jacket 12. For example, the cable jacket 12 may be made of a polyethylene, and the access features 34 may be strips of polypropylene, which weakly bonds to the polyethylene and can separate when pinched by the installer.

As can be seen in FIG. 1, the optical fibers 24 are densely packed within the buffer tubes 22. In one or more embodiments, the buffer tubes 22 have an inner surface defining a cross-sectional area (A_{buffer_tube}) perpendicular to the longitudinal axis of the buffer tubes 22. Further, the optical fibers 24 each have a cross-sectional area (A_{fiber1}, A_{fiber2}, . . . A_{fiberN}), and the total cross-sectional area (A_{fiber_total}) of the optical fibers 24 is the cumulative total of all of cross-sectional areas of the individual optical fibers 24 (A_{fiber1}+A_{fiber2}+ . . . +A_{fiberN}). The area inside the buffer tube 22 that is not occupied by the optical fibers 24 is referred to as free space, and as a percentage, the free space is equal to ((1−_{fiber_total}/A_{buffer_tube})×100%). In one or more embodiments, the free space inside the buffer tube is 50% or less, in particular 40% or less, and most particularly 30% or less. In one or more embodiments, the free space within the buffer tube 22 is at least 20%.

The low free space within the buffer tubes 22 corresponds to a high fiber density of the buffer tubes 22 and, in the construction of FIG. 1, of the optical fiber cable 10. Such high fiber density optical fiber cables 10 are desirable because they allow for the reduction of the cable diameter, allowing for the cable 10 to be used in smaller duct sizes. This increases the number of cables 10 in available duct space and achieves longer blowing distance using jetting as the installation method.

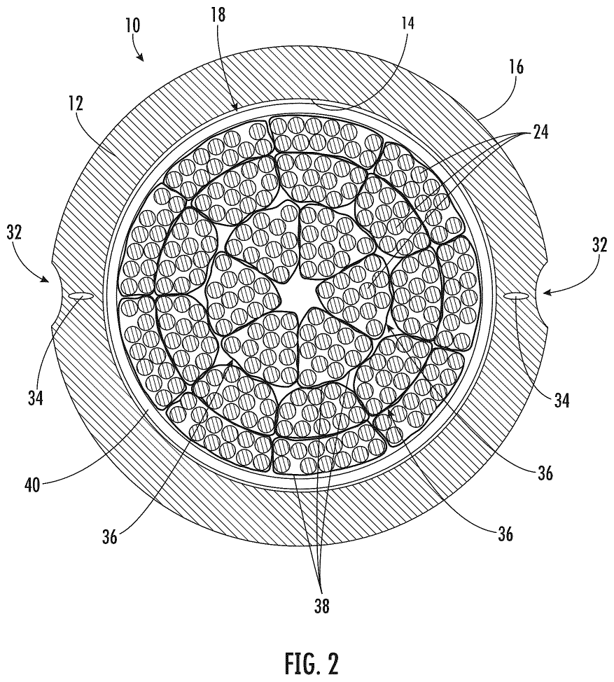

FIG. 2 depicts another embodiment of an optical fiber cable 10. As with the previously described embodiment, the optical fiber cable 10 has a cable jacket 12 with an inner surface 14 and an outer surface 16. The outer surface 16 is the outermost surface of the optical fiber cable 10, and the inner surface 14 defines a central bore 18. Disposed within the central bore 18 are a plurality of subunits referred to as “lumens” 36. The lumens 36 are comprised of a plurality of optical fibers 24 disposed within a membrane 38. As compared to the subunit 20 having a buffer tube 22 as shown in FIG. 1, the subunits in the form of lumens 36 shown in FIG. 2 are conformable and reconfigurable in terms of shape. That is, a buffer tube 22 is a substantially rigid, circular tube, whereas a membrane 38 of a lumen 36 can adopt a variety of shapes depending on how the lumens 36 are packed within the optical fiber cable 10.

In one or more embodiments, the reconfigurability of the lumen 36 is provided by using a thin and flexible membrane 38 around the optical fibers 24. In particular, the membrane 38 has a thickness (i.e., distance between an interior and an exterior surface of the membrane 38) of 0.05 mm or less, 0.04 mm or less, 0.03 mm or less, or 0.02 mm or less. In one or more embodiments, the membrane 38 has a thickness of 0.01 mm or more. For example, the membrane 38 may have a thickness in a range from 0.01 mm to 0.05 mm, 0.01 mm to 0.04 mm, 0.01 mm to 0.03 mm, 0.02 mm to 0.05 mm, 0.02 mm to 0.04 mm, or 0.02 to 0.03 mm. In one or more embodiments, the membrane 38 is comprised of a thermoplastic material, such as a polyester, a polypropylene, a polyamide, a polytetrafluoroethylene, or a polyethylene material. Further, in one or more embodiments, the material of the membrane 38 may be highly-filled with a filler material, such as chalk, clay, talc, or a flame retardant (e.g., alumina trihydrate or magnesium hydroxide), to enhance the tearability of the membrane 38 to provide ease of access to the optical fibers 24.

Advantageously, in the optical fiber cable 10 constructed according to FIG. 2, the optical fibers 24 act as the strength element of the optical fiber cable 10. That is, a separate strength element, such as a central strength member or tensile yarns, are not needed. Instead, the low free space within the lumens 28 and within the central bore 18 of the cable jacket 12 means that the optical fibers 24 are coupled together such that the cumulative effect provides tensile strength to the optical fiber cable 10. The tensile strength may be further enhanced by SZ-stranding the optical fibers 24 within the lumens 38 and/or SZ-stranding the lumens 38 in the central bore 18. In one or more embodiments, the lumens 38 may be surrounded by a binder 40 (e.g., an extruded binder film or binder yarns).

Optical fiber cables 10 constructed according to FIGS. 1 and 2 provide high fiber densities. In one or more embodiments, the optical fiber cables 10 according to the present disclosure have a fiber density of at least 4 fibers/mm². As used herein, the fiber density refers to the number of optical fibers 24 in a cable 10 divided by the cross-sectional area of the cable 10 perpendicular to the longitudinal axis of the cable 10 and as defined by the outer surface 16 of the cable jacket 12. In one or more embodiments, the optical fiber cables 10 according to the present disclosure have a fiber density of at least 5 fibers/mm², at least 6 fibers/mm², at least 7 fibers/mm², at least 8 fibers/mm², or at least 9 fibers/mm². In general, the optical fiber cable 10 shown in FIG. 2 will have a greater fiber density than the optical fiber cable 10 shown in FIG. 1 because it does not have a central strength member and because of the thinness of the lumens 38 as compared to the buffer tubes 22.

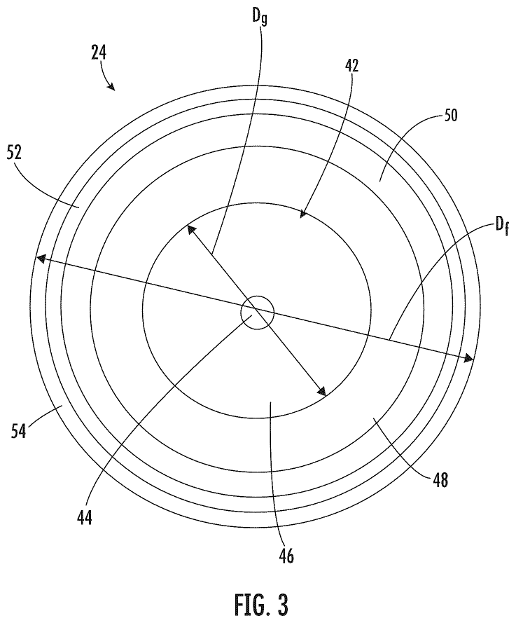

FIG. 3 provides a schematic depiction of a cross-section of an optical fiber 24 configured to provide water-blocking capabilities. As can be seen in FIG. 3, the optical fiber 24 has a glass region 42 that includes a core 44 and a cladding 46. Optical signals travel through the core 44, and the cladding 46 retains the optical signals within the core 44. The cladding 46 is surrounded by a primary coating layer 48, which is surrounded by a secondary coating layer 50. The primary coating layer 48 and the secondary coating layer 50 provide mechanical protection for the glass region 42 of the optical fiber 24. In general, the primary coating layer 48 is a softer coating layer having a low elastic modulus and potentially a low glass transition temperature, whereas the secondary coating layer 50 is a stronger coating layer having a high elastic modulus and potentially a high glass transition temperature. In one or more embodiments, the primary coating layer 48 has an elastic modulus of 1 MPa or less and a glass transition temperature (T_{g}) of −20° C. or less, and the secondary coating layer 50 has an elastic modulus of 1500 MPa or greater and a glass transition temperature (T_{g}) of 65° C. or more. In one or more embodiments, the primary coating layer 48 and the secondary coating layer 50 are formed from solvent-free, UV-curable resins, such as acrylates.

In one or more embodiments, the optical fiber 24 may include a color layer 52 surrounding the secondary coating layer 50. In one or more embodiments, the color layer 52 is a UV-curable ink layer that is used to identify a particular optical fiber 24 amongst several optical fibers 24 within the subunit 20 or lumen 36. For example, twelve optical fibers may be provided in the commonly used color-coded identification sequence of blue, orange, green, brown, gray, white, red, black, yellow, violet, pink, and aqua.

According to the present disclosure, at least one optical fiber 24 within the subunit 20 or lumen 36 also includes a UV-curable water-blocking layer 54 surrounding the secondary coating layer 50 or the color layer 52 if provided. In one or more embodiments, the color layer 52 may be omitted, and the secondary coating layer 50 or the water-blocking layer 54 may instead be provided with a colorant (e.g., ink, dye, or pigment) for identification purposes.

In one or more embodiments, the thickness of the water-blocking layer 54 is 10 microns or less. In one or more embodiments, the thickness of the water-blocking layer 54 is 5 microns or less. In one or more embodiments, the thickness of the water-blocking layer 54 is 4 microns or less. In one or more embodiments, the thickness of the water-blocking layer 54 is at least 1 micron. In one or more embodiments, the thickness of the water-blocking layer 54 is at least 2 microns. In one or more embodiments, the outer diameter D_{f} of the optical fiber 24 with the water-blocking layer 54 is 210 microns or less. In one or more embodiments, the outer diameter D_{f} of the optical fiber 24 with the water-blocking layer 54 is 200 microns or less. In one or more embodiments, the outer diameter D_{f} of the optical fiber 24 with the water-blocking layer 54 is 190 microns or less. In one or more embodiments, the outer diameter D_{f} of the optical fiber 24 with the water-blocking layer 54 is 180 microns or less.

In one or more embodiments, the optical fiber 24 has a glass diameter D_{g} (i.e., diameter of the glass region 42) of a diameter of 126 microns or less, in particular in a range from 124 microns to 126 microns, and particularly about 125 microns. In one or more embodiments, the optical fiber 24 has a glass diameter D_{g} of 110 microns or less. In one or more embodiments, the optical fiber 24 has a glass diameter D_{g} of 90 microns or less.

In one or more embodiments, the water-blocking layer 54 is comprised of a material having a water absorbing capacity of at least 20 g/g (i.e., 20 grams of water per gram of water-blocking material). In one or more embodiments, the water-blocking layer 54 is comprised of a material having a water absorbing capacity of at least 40 g/g. In one or more embodiments, the water-blocking layer 54 is comprised of a material having water absorbing capacity of at least 80 g/g. In one or more embodiments, the water-blocking layer 54 is comprised of a material having water absorbing capacity of up to 200 g/g. According to embodiments of the present disclosure, the material of the water-blocking layer 54 is a UV-cured resin that is formed from a solvent-free, UV-curable material. One example of commercially available solvent-free, UV-curable material for the water-blocking layer 54 is BLOCKCOAT® from Artofil (Deurne, Netherlands). As will be discussed more fully below, using a solvent-free, UV-curable material allows for the water-blocking layer 54 to be applied to the optical fiber 24 in line with the primary coating layer 48, secondary coating layer 50, and color layer 52 during the fiber drawing process.

In one or more embodiments, each subunit 20 or lumen 36 includes at least one optical fiber 24 having a water-blocking layer 54. In one or more embodiments, less than all of the optical fibers 24 in each subunit 20 or lumen 36 having a water-blocking layer 54. For example, in a subunit 20 or lumen 36 containing twelve optical fibers 24, at least one and up to eleven optical fibers 24 include the water-blocking layer 54. However, in such embodiments, not all twelve optical fibers 24 will have the water-blocking layer 54. In one or more embodiments, the ratio of optical fibers 24 having the water-blocking layer 54 to a total number of the optical fibers 24 in a subunit 20 or lumen 36 is less than 1, in particular less than 0.5, more particularly less than 0.2, and most particularly less than 0.1. Advantageously, the low free space in the high fiber density subunits 20 or lumens 36 not only provides low free space for the optical fibers 24 but also for water intrusion, allowing for less than all of the optical fibers 24 to be provided with the water-blocking layer 54. Further, because the water-blocking material is coated along the optical fiber 24, no additional water-blocking material is needed inside the subunits 20 or lumens 36.

Additionally, the number of optical fibers 24 provided within the water-blocking layer 54 within the subunit 20 or lumen 36 can be minimized by selective placement of the water-blocking optical fiber 24 within the subunit 20 or lumen 36. For example, the optical fiber or fibers 22 having the water-blocking layer 54 may be arranged in an outer layer of the optical fibers 24 within the subunit 20 or lumen 36. Still further, in one or more embodiments, optical fibers 24 having a water-blocking layer 54 may be placed within the central bore 18 in interstitial spaces between subunits 20 or lumens 36.

Besides the water-blocking functionality, the water-blocking layer 54 may provide additional benefits to the performance of the subunits 20. In particular, the solvent-free, UV-curable material of the water-blocking layer 54 tends to have a lower coefficient of friction than the color layer 52, which typically includes pigment particles that contribute to a higher coefficient of friction. That is, when the color layer 52 is the outermost layer of the optical fiber 24, the coefficient of friction of the optical fiber 24 with respect to the other optical fibers 24 tends to be higher than when the water-blocking layer 54 is the outermost layer. In one or more embodiments, the coefficient of friction of the water-blocking layer 54 is 80% or less, 70% or less, or 50% or less of the coefficient of friction of the color layer 52. The lower coefficient of friction allows for the optical fibers 24 to slide longitudinally more easily past each other to relieve tensile and contractive stresses during bending. The ability of the optical fibers 24 to slide in that manner is particularly relevant for high fiber density cables having low free space because the fibers 24 are mostly in constant contact with each other. Indeed, in the embodiment of the optical fiber cable 10 shown in FIG. 2, the coupling of the optical fibers 24 within the lumens 36 allows for the omission of a separate strength element, allowing the optical fibers 24 themselves to operate as a strength element within the optical fiber cable 10.

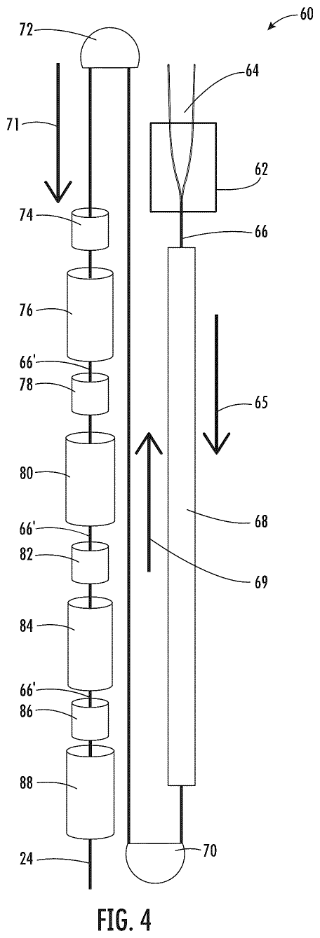

FIG. 4 provides a schematic depiction of a draw tower 60 for forming a water-blocking optical fiber 24 according to the present disclosure. The draw tower 60 includes a furnace 62 disposed at a top end of the draw tower 60. A glass preform 64 is positioned in the furnace 62, and the glass preform 64 is heated to a molten state and drawn in a first direction 65 (e.g., downwardly) through an opening in the furnace 62 to form a bare optical fiber 66 (i.e., the glass region 42 of the optical fiber 24 as shown in FIG. 3). In one or more embodiments, the bare optical fiber 66 is optionally directed through a slow cooling device 68 that controls the cooling rate of the bare optical fiber 66 such that the bare optical fiber 66 cools at a slower rate than the bare optical fiber 66 would cool in the ambient atmosphere. In one or more embodiments, the slow cooling device 68 is a furnace operated at a temperature ranging between 900° C. and 1250° C., in particular ranging between 1000° C. and 1200° C. After passing a certain distance in the first direction from the top end or upon reaching a bottom end of the draw tower 60, the bare optical fiber 66 is redirected in a second direction 69 (e.g., upwardly) around a first fluid bearing 70. The primary coating layer 48, secondary coating layer 50, optional color layer 52, and water-blocking layer 54 can be applied to the bare optical fiber 66 after redirection by the first fluid bearing 70. For example, in one or more embodiments, the primary coating layer 48, the secondary coating layer 50, the optional color layer 52, and the water-blocking layer 54 can be applied with the bare optical fiber 66 as it moves horizontally or diagonally in the second direction 69.

However, in one or more other embodiments, the bare optical fiber 66 may be redirected again in a third direction 71 (e.g., downwardly) by a second fluid bearing 72. As shown in FIG. 4, the third direction 71 is a same direction as the first direction 65. When travelling in this third direction 71, the primary coating layer 48, secondary coating layer 50, optional color layer 52, and water-blocking layer 54 are applied to the bare optical fiber 66. As shown in FIG. 4, the bare optical fiber 66 first travels through one or more applicators followed by one or more UV curing chambers in which each coating layer is applied and cured before application of the subsequent coating layer. The coating applicators may be coating dies or other dip-coating structures. In one or more embodiments, the bare optical fiber 66 travels through a first applicator 74 that applies the material of the primary coating layer 48 and a first UV curing chamber 76 that cures the primary coating layer 48. The coated fiber 66′ then travels through a second applicator 78 that applies the material of the secondary coating layer 50 and a second UV curing chamber 80 that cures the secondary coating layer 50. If, as in the embodiment shown in FIG. 4, the optical fiber 24 has a color layer 52, the coated fiber 66′ travels through a third applicator 82 that applies the material of the color layer 52 and a third UV curing chamber 84 that cures the color layer 52. The coated fiber 66′ then passes through a fourth applicator 86 that applies the solvent-free, UV-curable water-blocking material of the water-blocking layer 54 and a fourth UV curing chamber 88 that cures the water-blocking layer 54 to provide the water-blocking optical fiber 24.

The use of the fluid bearings 70, 72 allows for all of the coating layers to be applied during the fiber drawing process. In particular, the drawing tower 60 for an optical fiber 24 is multiple stories high, and therefore, if all of the coating layers were applied with the optical fiber 24 being drawn in a single direction, the height of the drawing tower 60 would be significantly higher. For this reason, bare optical fibers are often drawn on one processing line and then coated on a separate processing line. However, this increases the real estate necessary for producing the optical fiber. By redirecting the bare fiber 66 using the fluid bearings 70, 72, the height of the drawing tower 66 can essentially be recycled and used for application of the coating layers, including the water-blocking layer 54. Advantageously, the coating layers can be applied at high draw speeds of 30 m/s or greater.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. An optical fiber cable, comprising:
a cable jacket comprising an inner surface and an outer surface, the outer surface defining an outermost surface of the optical fiber cable and the inner surface defining a central bore extending along a longitudinal axis of the optical fiber cable; and
a plurality of subunits disposed within the central bore, each subunit of the plurality of subunits comprising a plurality of optical fibers;
wherein the plurality of optical fibers of at least one subunit of the plurality of subunits comprises at least one water-blocking optical fiber having an outermost coating layer of a UV-cured resin configured to absorb at least 20 grams of water per gram of the UV-cured resin;
wherein the optical fiber cable has a cross-sectional area defined by the outer surface of the cable jacket, the cross-sectional area being perpendicular to the longitudinal axis; and
wherein the optical fiber cable comprises a fiber density of at least 4 fibers/mm² as measured at the cross-sectional area.

2. The optical fiber cable of claim 1, wherein the outermost coating layer has a thickness of 10 microns or less.

3. The optical fiber cable of claim 1, wherein the at least one subunit comprises a ratio of the at least one water-blocking optical fiber to the plurality of optical fibers of less than 1.

4. The optical fiber cable of claim 3, wherein the ratio is less than 0.5.

5. The optical fiber cable of claim 1, wherein each subunit of the plurality of subunits comprises a buffer tube having a wall thickness of at least 0.1 mm.

6. The optical fiber cable of claim 5, wherein the plurality of subunits is stranded around a central strength member.

7. The optical fiber cable of claim 1, wherein the plurality of subunits are lumens, each lumen comprising a membrane having a thickness of 0.05 mm or less surrounding the plurality of optical fibers.

8. The optical fiber cable of claim 7, wherein the optical fiber cable does not comprise a central strength member or tensile yarns.

9. The optical fiber cable of claim 1, wherein the at least one water-blocking optical fiber comprises a glass core, a glass cladding surrounding the core, a primary coating layer surrounding the glass cladding, a secondary coating layer surrounding the primary coating layer, and the outermost coating layer surrounding the secondary coating layer.

10. The optical fiber cable of claim 9, wherein the outermost coating layer is in contact with the secondary coating layer.

11. The optical fiber cable of claim 10, wherein at least one of the secondary coating layer or the outermost coating layer comprises a colorant.

12. The optical fiber cable of claim 9, wherein the at least one water-blocking optical fiber comprises a color layer disposed between and in contact with each of the secondary coating layer and the outermost coating layer.

13. A method of forming a water-blocking optical fiber, comprising:
drawing a bare glass fiber from a glass preform within a furnace, the furnace being disposed at one end of a draw tower and the drawing proceeding in a first direction;
redirecting the bare glass fiber around at least one fluid bearing such that the drawing proceeds at least partially in a second direction, the second direction being different from the first direction;
applying and UV curing each of a primary coating layer, a secondary coating layer, and an outermost coating layer on the bare glass fiber on a same processing line including the drawing and redirecting, wherein the outermost coating layer is formed from a solvent-free, UV-curable material configured to absorb at least 20 grams of water per gram of the solvent-free, UV-curable material.

14. The method of claim 13, wherein the applying and UV curing provides an outermost coating layer having a thickness of 10 microns or less.

15. The method of claim 13, wherein the applying and UV curing further comprises applying the outermost coating layer directly around the secondary coating layer.

16. The method of claim 15, wherein the method further comprises providing a colorant in at least one of the secondary coating layer or the outermost coating layer.

17. The method of claim 13, wherein the applying and UV curing further comprises applying and UV curing a color layer between applying and UV curing the secondary coating layer and applying and UV curing the outermost coating layer.

18. The method of claim 13, wherein the drawing further comprising drawing the bare glass fiber at a rate of at least 30 m/s.

19. The method of claim 13, wherein the applying and UV curing occurs while the bare optical fiber proceeds in the second direction.

20. The method of claim 13, wherein the redirecting comprises redirecting the bare optical fiber around a first fluid bearing such that the drawing proceeds in the second direction and further redirecting the bare optical fiber around a second fluid bearing such that the drawing proceeds in a third direction, and wherein the applying and UV curing occurs while the bare optical fiber proceeds in the third direction.

21. The method of claim 20, wherein the third direction is a same direction as the first direction.
